(19) United States
(12) Patent Application Publication
(10) Pub. No.: US 2005/0042501 A1
(43) Pub. Date: Feb. 24, 2005

(54) Assistant apparatus for a battery cover

(76) Inventor: Ming-Chun Hou, Taipei City (TW)

Correspondence Address: BIRCH STEWART KOLASCH & BIRCH, PO BOX 747, FALLS CHURCH, VA, 22040-0747, US

(21) Appl. No.: 10/642,987

(22) Filed: Aug. 18, 2003

(51) Int. Cl. H01M 2/10

(52) U.S. Cl. 429/97; 429/123; 429/100

(57) ABSTRACT

An assistant apparatus for a battery cover is described. An elastic apparatus is configured on an interface between a portable electronic device body and a battery cover. The battery cover is separated from the portable electronic device body due to the elastic force from the elastic apparatus.

### BACKGROUND OF THE INVENTION

1. Field of Invention

The present invention relates to a portable electronic device. More particularly, the present invention relates to an assistant apparatus for a battery cover.

2. Description of Related Art

Mobile telephones are portable and wireless telephone devices installed on conveyances, such as vehicles and ships, or carried by a user. Mobile telephones are different from extensions of the telephone or long distance radio transceivers. Mobile telephones provide users with the benefits of the same functions of and greater convenience than immobile telephones. Cooperating with international direct dialing, mobile telephone users can communicate with any other person in the world in an available range of a mobile telephone system.

Generally, a mobile telephone relies on a battery for power during use. A mobile telephone consumes a large amount of power during operation, and rechargeable secondary batteries are therefore the best choice of power supply. Secondary batteries have advantages such as high energy density, able to be more miniaturized, a lighter weight and greater thinness, high safety, and low cost. The secondary batteries on the market mainly are Ni-MH and Li-ion batteries.

Secondary batteries of the mobile telephone are interchangeable; a user can swap out an expended battery for a fully charged battery so as to keep the mobile telephone operating. Mobile telephones are designed to allow battery exchange to accommodate a user's needs.

The battery usually is installed inside the mobile telephone and a battery cover then is used to cover the battery. The battery cover is attached to the mobile telephone body by a latch structure and protects the battery, the mobile telephone body and the joint therebetween from outside environmental contaminants, like vapor or dust, which would hinder operation of the mobile telephone. In some new designs, the battery and the battery cover are combined together to form a sheet secondary battery. This sheet secondary battery is a battery with a shape of the battery cover. The battery is thus changed just by changing the battery cover.

However, in spite of the simplicity of changing a battery or battery cover, actually changing the battery is problematic because the battery cover is difficult to remove. The conventional design only provides a notch at the joint between the battery cover and the mobile telephone body and a user must grip the notch with a hand or use another tool to separate the battery cover from the mobile telephone body. The user often damages the battery cover or phone, either in appearance or structure, or both, and may cause the phone to cease functioning.

### SUMMARY OF THE INVENTION

It is therefore an objective of the present invention to provide an assistant apparatus for a battery cover that satisfies the need to facilitate separation of the battery cover from the portable electronic device body.

In accordance with the foregoing and other objectives of the present invention, an assistant apparatus for a battery cover is described. An elastic apparatus is installed on an interface between a portable electronic device body and a battery cover. The battery cover is separated from the portable electronic device due to the elastic force exerted by the elastic apparatus.

In one preferred embodiment of the present invention, the elastic apparatus is installed on the portable electronic device body or the battery cover, and the quantity and the position thereof are not limited. The main function of the elastic apparatus is separate the battery cover from the portable electronic device body by the elastic force exerted by the elastic apparatus.

The elastic apparatus in the first embodiment is a slice. The slice is a part of the mobile telephone body, segmented from the mobile telephone body and raised upwards at an angle.

The elastic apparatus in the second embodiment is a metal spring leaf. The metal spring leaf includes two portions; the first portion is attached to the mobile telephone body, and the second portion is at an angle upwards from the portion.

The elastic apparatus in the third embodiment is a spring. One end of the spring is attached to the mobile telephone body.

The elastic apparatus in the fourth embodiment is an elastic pillar. One end of the elastic pillars is configured in a pit of the mobile telephone body. In this embodiment, a material of the elastic pillar is rubber, which has an elastic force intended to return to the original state during compression.

When the battery cover covers downward from the top of the mobile telephone body, a compression force deforms or compresses the elastic apparatus, and the elastic apparatus therefore has an elastic force intended to return to the original state. But the latch structure is latched when the battery cover is attached to the mobile telephone body, and the elastic force of the elastic apparatus is thus stored until the latch structure is released.

After releasing the latch structure, the elastic force stored in the elastic apparatus causes the latch to return to its original state. The elastic apparatus pushes the battery cover away from the mobile telephone body, thus facilitating separation of the battery cover and telephone body for battery exchange.

In conclusion, the invention facilitates separation of the battery cover from the mobile telephone body for battery changing. The elastic apparatus of this invention is easily installed, cheap, and raises product values. In addition, this invention can be applied in not only mobile telephones, but also other portable electronic devices employing secondary batteries, such as personal digital assistants, to facilitate battery interchange.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A illustrates a schematic view of one preferred embodiment of this invention;

FIG. 1B is illustrated a schematic view of another preferred embodiment of this invention;

FIG. 2A illustrates a side view of one preferred embodiment of the elastic apparatus in the invention;

FIG. 2B illustrates a side view of another preferred embodiment of the elastic apparatus in the invention;

FIG. 2C illustrates a side view of another preferred embodiment of the elastic apparatus in the invention;

FIG. 2D illustrates a side view of another preferred embodiment of the elastic apparatus in the invention;

FIG. 2E is a top view of FIG. 2D; and

FIG. 2F is a cross-sectional view taken along line AA′ in FIG. 2E.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an assistant apparatus for a battery cover to facilitate separation of the battery cover from the portable electronic device body.

This invention installs an elastic apparatus on an interface between a portable electronic device body and a battery cover. The battery cover is separated from the portable electronic device due to the elastic force exerted by the elastic apparatus.

The portable electronic device is powered by secondary batteries, and usually uses a battery cover to protect the battery, the mobile telephone body and the joint there between. The invention is applicable to mobile telephones, personal digital assistants, and other portable electronic devices.

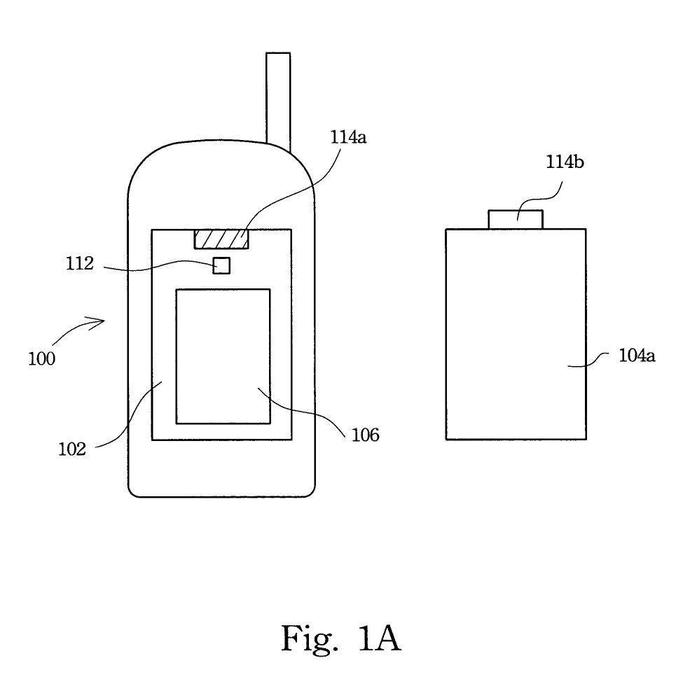

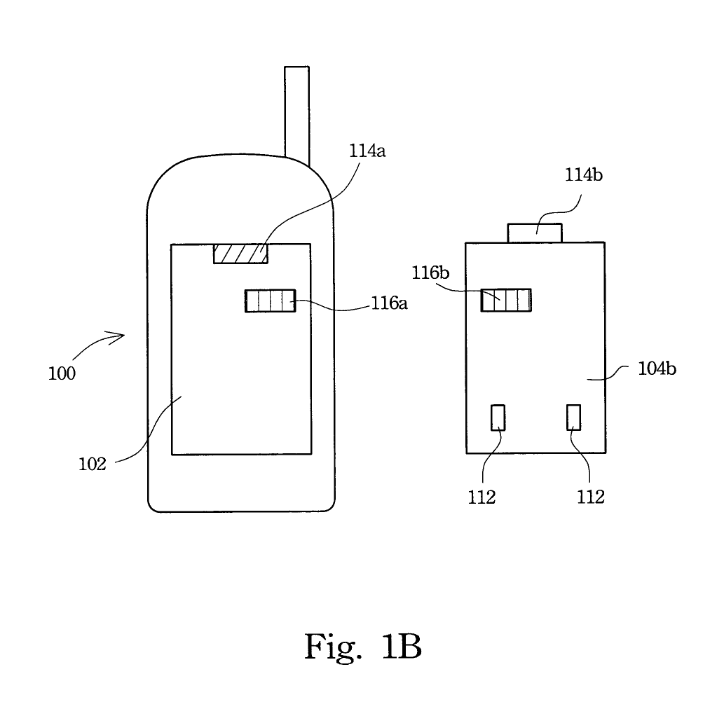

FIG. 1A illustrates a schematic view of one preferred embodiment of this invention. This preferred embodiment is a mobile telephone 100, and an elastic apparatus 112 is installed on a surface of a mobile telephone body 102 in contact with a battery cover 104a. A latch structure 114a/114b of the mobile telephone 100 is on the latch to attach the battery cover 104a to the mobile telephone body 102, thus protecting the battery 106, the mobile telephone body 102 and the joint there between. Without the protection of the battery cover 104a, contamination from improper touch by fingers or vapor and dust might cause serious damage to internal circuits and other portions therein.

In the embodiment illustrated in FIG. 1A, a single elastic apparatus is installed on the mobile telephone body 102 near the latch structure 114a/114b. The elastic apparatus of this invention also can be installed on the battery cover, more than one can be installed, and a position thereof need not be near the latch structure 114a/114b. The main function of the elastic apparatus is to separate the battery cover from the portable electronic device body by the elastic force of the elastic apparatus. The installed position and installed quantity are not limited by this embodiment; other modifications and variations fall within the scope of this invention also can be covered.

Following is another embodiment of the invention, clearly explaining how the invention can be applied in various situations as described above. A plurality of elastic apparatuses is installed on the battery cover, not positioned near the latch structure, and the battery cover comprises a secondary battery.

FIG. 1B illustrates a schematic view of another preferred embodiment of this invention. This preferred embodiment is a mobile telephone 100, and two elastic apparatus 112 are installed on a surface of a battery cover 104b in contact with a mobile telephone body 102. It is noted that the battery cover 104b itself comprises a secondary battery, and a junction 116b of the battery cover 104b is coupled with a junction 116a of the mobile telephone body 102 to supply power to the mobile telephone 100.

A latch structure 114a/114b of the mobile telephone 100 is on the latch to couple the battery cover 104b and the mobile telephone body 102, thus protecting the battery 106, the mobile telephone body 102 and the junction 116a and 116b therebetween. In addition, FIG. 1B illustrates two elastic apparatuses 112, and not positioned near the latch structure 114a/114b. This demonstrates that installation position and quantity of elastic apparatus are not limited and other modifications and variations fall within the scope of this invention.

Four embodiments as following interpret in detail the structure of the elastic apparatus. For convenient interpretation, the following descriptions all use a single elastic apparatus 112 installed on the mobile telephone body 102 as an example interpreting the four different embodiments of the elastic apparatus. However, as in the foregoing description, other situations where, for example, the elastic apparatus is installed on the battery cover, or the battery cover itself comprises a battery, also can use the elastic apparatus presented in the following four embodiments with no difficulty.

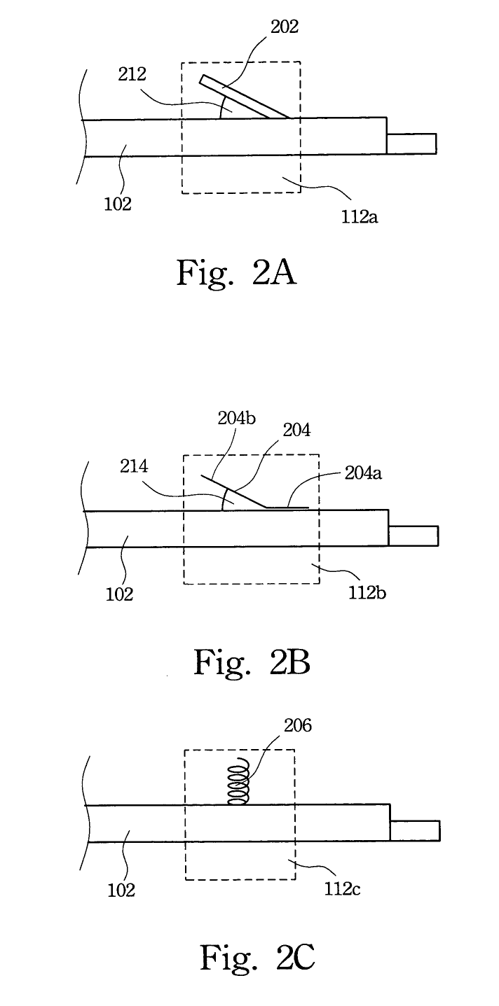

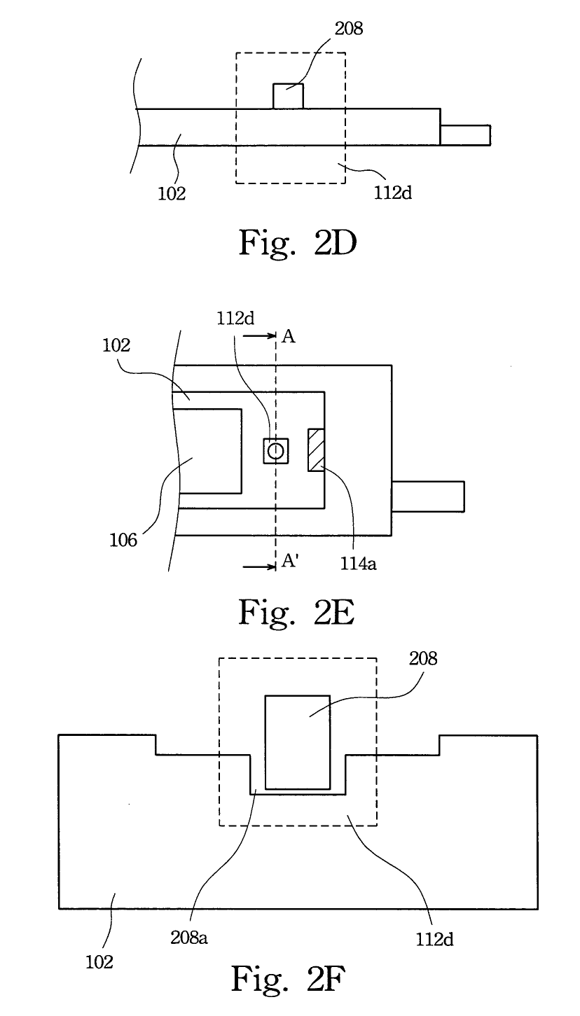

FIG. 2A illustrates a side view of one preferred embodiment of the elastic apparatus in the invention. The elastic apparatus 112a in this embodiment is a slice 202. The slice 202 is a part of the mobile telephone body 102, segmented from the mobile telephone body 102 and raised upwards at an angle 212.

When the battery cover 104a covers downward from the top of the mobile telephone body 102, a compression force moves down a raised end of the slice 202, and the angle 212 is reduced. The slice 202 therefore has an elastic force intended to return it to the original state. But the latch structure 114a/114b is on the latch to attach the battery cover 104a to the mobile telephone body 102, and the elastic force of the elastic apparatus 112a is stored until the latch structure 114a/114b is released.

After releasing the latch structure 114a/114b, the elastic force stored in the elastic apparatus 112a makes the end of the slice 202 return to the original raised state. The angle 212 returns to the original angle, and the slice 202 pushes the battery cover 104a away from the mobile telephone body 102, thus facilitating separation to change battery 106.

FIG. 2B illustrates a side view of another preferred embodiment of the elastic apparatus in the invention. The elastic apparatus 112b in this embodiment is a metal spring leaf 204. The metal spring leaf 204 includes two portions 204a and 204b; portion 204a is attached to the mobile telephone body 102, and portion 204b is at an angle 214 upwards from the portion 204a.

Similarly, when the battery cover 104a covers downward from the top of the mobile telephone body 102, a compression force moves down the portion 204b of the metal spring leaf 204, and the angle 214 is reduced. Portion 204b therefore has an elastic force intended to return to the original state. But the latch structure 114a/114b is on the latch to attach the battery cover 104a to the mobile telephone body 102, and the elastic force of the elastic apparatus 112b is stored until the latch structure 114a/114b is released.

After releasing the latch structure 114a/114b, the elastic force stored in the elastic apparatus 112b makes the portion 204b of the metal spring leaf 204 return to the original raised state. The angle 214 returns to the original angle, and the portion 204b pushes the battery cover 104a away from the mobile telephone body 102, thus facilitating separation to change battery 106.

Moreover, the shape of metal spring leaf 204 can be varied; this embodiment only illustrates a simplest structure thereof for interpretation of elastic apparatus 112b of the invention. However, the metal spring leaf can be designed in many different ways to enhance the elastic force thereof; for example, the metal spring leaf can be designed as a reverse “V”, and is not limited to a single sheet shape as illustrated in FIG. 2B.

FIG. 2C illustrates a side view of another preferred embodiment of the elastic apparatus in the invention. The elastic apparatus 112c in this embodiment is a spring 206. One end of the spring 206 is attached to the mobile telephone body 102.

When the battery cover 104a covers downward from the top of the mobile telephone body 102, a compression force compresses the spring 206. Spring 206 therefore has an elastic force intended to return to the original state. But the latch structure 114a/114b is on the latch to attach the battery cover 104a to the mobile telephone body 102, and the elastic force of the elastic apparatus 112c is stored until the latch structure 114a/114b is released.

After releasing the latch structure 114a/114b, the elastic force stored in the elastic apparatus 112c makes the spring 206 return to the original state. The other end of the spring 206 pushes the battery cover 104a away from the mobile telephone body 102, thus facilitating separation to change battery106.

FIG. 2D illustrates a side view of another preferred embodiment of the elastic apparatus in the invention. The elastic apparatus 112d in this embodiment is an elastic pillar 208; the following description of the elastic pillar 208 refers to FIG. 2E and FIG. 2F. FIG. 2E is a top view of FIG. 2D, and FIG. 2F is a cross-sectional view taken along line AA′ in FIG. 2E. One end of the elastic pillars 208 is configured in a pit 208a of the mobile telephone body 102. In this embodiment, a material of the elastic pillar is rubber, which has an elastic force intended to return to the original state while being compressed.

When the battery cover 104a covers downward from the top of the mobile telephone body 102, a compression force compresses the elastic pillar 208, and the height of the elastic pillar 208 is reduced. The elastic pillar 208 therefore has an elastic force intended to return to the original state. But the latch structure 114a/114b 100 is on the latch to attach the battery cover 104a to the mobile telephone body 102, and the elastic force of the elastic apparatus 112d is stored until the latch structure 114a/114b is released.

After releasing the latch structure 114a/114b, the elastic force stored in the elastic apparatus 112d makes the elastic pillar 208 return to the original raised state. The other end of the elastic pillar 208 pushes the battery cover 104a away from the mobile telephone body 102, thus facilitating separation to change battery106.

The shapes of elastic pillar 208 and the pit 208a are not limited by FIG. 2E, and can be any other shapes suitable for mobile telephone designs. In this embodiment the elastic pillar 208 is a solid object made of rubber, which is cheap, wear-resistant, and not easily damaged by acid or other materials. The elastic apparatus thus has long lifetime and wide application scope.

In conclusion, the invention facilitates users separating the battery cover from the mobile telephone body to interchange the battery. The elastic apparatus of this invention is easily installed, cheap, and raises product values. In addition, this invention can be applied not only in mobile telephones, but also other portable electronic devices powered by secondary batteries, such as personal digital assistants, to facilitate interchanging the batteries.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An assistant apparatus for a battery cover, suitable for use in a portable electronic device, the portable electronic device having a device body and a battery cover, the battery cover being attached to the device body by a latch structure, the assistant apparatus for a battery cover comprising:
at least one elastic apparatus, configured on a first surface of the battery cover, the first surface adjacent to the device body, wherein a force of the elastic apparatus separates the battery cover from the device body after releasing the latch structure.

2. The assistant apparatus for a battery cover of claim 1, wherein the portable electronic device is a mobile phone or a personal digital assistant.

3. The assistant apparatus for a battery cover of claim 1, wherein the battery cover comprises a battery.

4. The assistant apparatus for a battery cover of claim 1, wherein the elastic apparatus is a metal spring leaf, the metal spring leaf including a first portion and a second portion, wherein the first portion is attached to the first surface, and the second portion is at an angle with the first portion, when the battery cover and the device body are on the latch, the second portion is compressed by the device body and the angle is changed, and after releasing the latch structure, the second portion pushes the device body so as to separate the battery cover from the device body.

5. The assistant apparatus for a battery cover of claim 1, wherein the elastic apparatus is a spring.

6. The assistant apparatus for a battery cover of claim 1, wherein the elastic apparatus is a slice, the slice is attached to the battery cover and at an angel with the battery cover, when the battery cover and the device body are on the latch, the slice is compressed by the device body and the angle is changed, and after releasing the latch structure, the slice pushes the device body so as to separate the battery cover from the device body.

7. The assistant apparatus for a battery cover of claim 6, wherein the slice and the battery cover are integrally formed.

8. The assistant apparatus for a battery cover of claim 1, wherein the elastic apparatus is an elastic pillar, the elastic pillar is configured in a pit of the battery cover, when the battery cover and the device body are on the latch, the elastic pillar is compressed by the device body and a height of the elastic pillar is changed, and after releasing the latch structure, the elastic pillar pushes the device body so as to separate the battery cover from the device body.

9. The assistant apparatus for a battery cover of claim 8, wherein a material of the elastic pillar is rubber.

10. An assistant apparatus for a battery cover, suitable for use in a portable electronic device, the portable electronic device having a device body and a battery cover, the battery cover being attached to the device body by a latch structure, the assistant apparatus for a battery cover comprising:
at least one elastic apparatus, configured on a first surface of the device body, the first surface adjacent to the battery cover, wherein a force of the elastic apparatus separates the battery cover from the device body after releasing the latch structure.

11. The assistant apparatus for a battery cover of claim 10, wherein the portable electronic device is a mobile phone or a personal digital assistant.

12. The assistant apparatus for a battery cover of claim 10, wherein the battery cover comprises a battery.

13. The assistant apparatus for a battery cover of claim 10, wherein the elastic apparatus is a metal spring leaf, the metal spring leaf including a first portion and a second portion, wherein the first portion is attached to the first surface, the second portion is at an angle with the first portion, when the battery cover and the device body are on the latch, the second portion is compressed by the battery cover and the angle is changed, and after releasing the latch structure, the second portion pushes the battery cover so as to separate the battery cover from the device body.

14. The assistant apparatus for a battery cover of claim 10, wherein the elastic apparatus is a spring.

15. The assistant apparatus for a battery cover of claim 10, wherein the elastic apparatus is a slice, the slice is attached to the device body and at an angel with the device body, wherein when the battery cover and the device body are on the latch, the slice is compressed by the battery cover and the angle is changed, and after releasing the latch structure, the slice pushes the battery cover so as to separate the battery cover from the device body.

16. The assistant apparatus for a battery cover of claim 15, wherein the slice and the device body are integrally formed.

17. The assistant apparatus for a battery cover of claim 10, wherein the elastic apparatus is an elastic pillar, the elastic pillar is configured in a pit of the device body, when the battery cover and the device body are on the latch, the elastic pillar is compressed by the battery cover and a height of the elastic pillar is changed, and after releasing the latch structure, the elastic pillar pushes the battery cover so as to separate the battery cover from the device body.

18. The assistant apparatus for a battery cover of claim 17, wherein a material of the elastic pillar is rubber.
